(19) United States
(12) Patent Application Publication
(10) Pub. No.: US 2007/0193570 A1
(43) Pub. Date: Aug. 23, 2007

(54) CAMERA FOR A WEAPON

(76) Inventors: Keith R. Lieb, Hazelwood, MO (US); William Brian Bowden, Warrenton, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/740,732

(22) Filed: Apr. 26, 2007

(51) Int. Cl. F41B 5/00; H04N 7/18

(52) U.S. Cl. 124/86; 348/61

(57) ABSTRACT

A camera for a bow including a hollow body comprising a bow stabilizer, a camera and a transmitter. The hollow body is adapted for attachment to a bow stabilizer mount commonly associated with a hunter's bow and has a bore in one end. The camera is mounted within the hollow body adjacent the bore such that light traveling through the bore may be captured by the camera. The transmitter is located within the hollow body and communicates with the camera for transmitting video information captured by the camera to a remotely located receiver.

### FIELD OF THE INVENTION

The invention relates to hunting. More specifically, the invention relates to method of recording a video of a hunt with a camera-enabled bow.

### BACKGROUND OF THE INVENTION

In the United States, hunting is a popular sport. About 14 million people a year buy hunting licenses in the U.S. Adding to that people who own lifetime licenses and youth hunters under 17 who do not need to buy licenses in many states, there are close to 19 million hunters in the U.S. each year. Adding further those who don't hunt each year but still consider themselves active hunters, the total number of hunters is closer to 24 million.

Many hunters like to record their hunt for the purposes of recording and reliving an exciting and memorable moment or for the purpose of sharing a successful hunt with others. For hunting some types of animals, such as deer, bows are a common weapon and most states reserve certain seasons for bow hunting. Bow hunting has a higher degree of difficulty than gun hunting, primarily due to the shorter range of a bow, but generally has a longer season than gun hunting, particularly for deer hunting. Therefore, bow hunting is generally enjoyed by the most avid hunters who are most likely to spend money on equipment such as video recording equipment.

A hunter does not have sufficient time to set up a camera and move it to the proper direction to capture his shot. Most animals are particularly keen to movement, so the hunter cannot redirect the camera once the animal has presented itself. Moreover, before getting off a shot, the animal will likely move from the location where it has presented itself. Therefore, a particular problem with recording video from a hunt is directing a camera.

One prior art device, known as BOWS EYE, mounts a camera on bow so that the camera is always pointed at the prey. The camera is in wireless communication with a recording device that stores the video being produced by the hunter. However, a particular problem with this device is that the camera is mounted to the bow in such a manner that the camera interferes with the weight, balance, appearance of the bow. Moreover, BOWS EYE is placed in a peculiar location such that it could be damaged or misaligned, such as while climbing and descending from a tree stand.

Therefore, there is a need in the art for a bow mounted wireless camera that does not affect the usage of the bow, is inexpensive, and is not easily damaged or misaligned.

### SUMMARY OF THE INVENTION

The present invention provides a camera for a bow comprising a hollow body comprising a bow stabilizer, a camera and a transmitter. The hollow body is adapted for attachment to a bow stabilizer mount commonly associated with a hunter's bow, and has a bore in one end. The camera is mounted within the hollow body adjacent the bore such that light traveling through the bore may be captured by the camera. The transmitter is located within the hollow body and communicates with the camera for transmitting video information captured by the camera to a remotely located receiver.

### BRIEF DESCRIPTION OF THE DRAWINGS

FIG. 1 is a plan view of a hunter with a bow according to an embodiment of the present invention;

FIG. 2 is a sectional view of a camera according to an embodiment of the present invention; and

FIG. 3 is a diagrammatical view of camera and receiver according to an embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The preferred embodiment of the present invention provides a camera mounted in a bow stabilizer. The camera is attached to a transmitter which transmits the video and, optionally, audio information from the camera to a receiver located remotely. The remotely located receiver stores the information on a video recorder physically connected to the receiver.

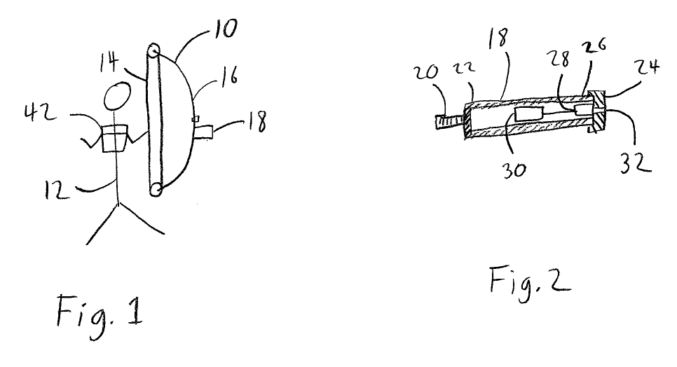

In that regard and referring to FIG. 1, there is provided a bow 10 operated by a hunter 12. The bow 10 comprises a bow string 14 and bow frame 16. The bow frame 16 has a bow stabilizer 18 mounted to it. The bow stabilizer 18 is a hollow cylindrical tube having a threaded rod 20 attached to one end 22 and a cap 24 covering the other end 26. The threaded rod 20 allows the bow stabilizer 18 to be easily mounted to the bow frame 16 of the bow 10.

The bow stabilizer 18 further includes a camera 28 and transmitter 30 located therein. While shown separately, the camera 28 and transmitter 30 may be a single unitary device without departing from the scope of the present invention. The camera 28 receives a view of the area in front of the bow 10 though a bore 32 in the cap 24 of the bow stabilizer 18. The bore 32 may be covered by a transparent material or it may be an open bore having no transparent covering without departing from the scope of the present invention. The benefits of mounting the camera in the bow stabilizer are many. First, the camera is always pointed in the direction that the bow is pointed, and the hunter does not have to make unnecessary movements to adjust the camera which may startle an animal being hunted and cause it to run away. The stabilizer-mounted camera can easily respond to quick movements of the hunter in response to movement of the animal. Second, the stabilizer mounted camera is protected from the elements of rain, wind and snow by being placed within the confines of the bow stabilizer. Third, the camera is rigidly mounted to the bow and cannot be easily misdirected by bumping. Most bows are equipped with a threaded hole for mounting a bow stabilizer to the bow; therefore, as a fourth advantage the camera is almost universally adaptable to existing bows.

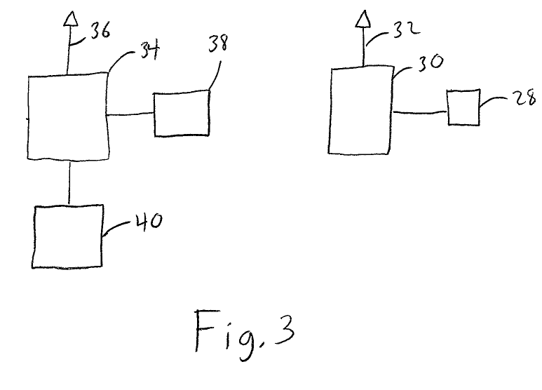

Referring to FIG. 3, the camera 28 is attached to the transmitter 30 which includes an antenna 32 for transmitting the signal. A receiver 34 also includes an antenna 36 for receiving the transmitted signal and communicating the audio and video signal to a solid state memory device 38, such as an MP4 digital video recorder. The receiver 34 is also connected to a battery source 40. The receiver 34, solid state memory device 38 and battery source 40 are preferably located near the hunter 12 to allow the signal to be transmitted with low power to save battery resources. In the most preferred embodiment, the hunter 12 would carry the receiver 34, solid state memory device 38 and battery source 40 in a backpack 42 (FIG. 1) carried by the hunter 12. In this way the hunter 12 could start and stop the recording or the solid state memory device 38, as desired.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

I claim:

1. A camera for a bow comprising:
a hollow body comprising a bow stabilizer and adapted for attachment to a bow stabilizer mount commonly associated with a hunter's bow, the hollow body having a bore in one end;
a camera mounted within the hollow body adjacent the bore such that light traveling through the bore may be captured by the camera; and
a transmitter located within the hollow body and attached to the camera for transmitting video information captured by the camera to a remotely located receiver.

2. The camera of claim 1 further comprising the receiver for receiving the transmitted signal and a recorder attached to the receiver for recording the transmitted signal.

3. The camera of claim 2 wherein the recorder is a solid state memory device.

4. The camera of claim 1 wherein the bow stabilizer includes a cap at one end thereof, wherein the cap defines the bore.

5. The camera of claim 1 wherein the bow incorporates a threaded rod for attachment to the bow.

6. A bow comprising:
a bow frame comprising one or more pulleys having a bow string attached to the bow frame and threaded over the pulleys;
a bow stabilizer mount;
a hollow body comprising a bow stabilizer and adapted for attachment to the bow stabilizer mount, the hollow body having a bore in one end;
a camera mounted within the hollow body adjacent the bore such that light traveling through the bore may be captured by the camera; and
a transmitter located within the hollow body and attached to the camera for transmitting video information captured by the camera to a remotely located receiver.

7. The camera of claim 6 further comprising the receiver for receiving the transmitted signal and a recorder attached to the receiver for recording the transmitted signal.

8. The camera of claim 7 wherein the recorder is a solid state memory device.

9. The camera of claim 6 wherein the bow stabilizer includes a cap at one end thereof, wherein the cap defines the bore.

10. The camera of claim 6 wherein the bow incorporates a threaded rod for attachment to the bow.

11. A camera for a weapon comprising:
a hollow, cylindrical body adapted for attachment to a weapon, the hollow body having a bore in one end;
a camera mounted within the hollow body adjacent the bore such that light traveling through the bore may be captured by the camera; and
a transmitter located within the hollow body and attached to the camera for transmitting video information captured by the camera to a remotely located receiver.

12. The camera of claim 11 further comprising a receiver for receiving the transmitted signal and a recorder attached to the receiver for recording the transmitted signal.

13. The camera of claim 12 wherein the recorder is a solid state memory device.

14. The camera of claim 11 wherein the hollow body includes a cap at one end thereof, wherein the cap defines the bore.
